(19) United States
(12) Patent Application Publication
(10) Pub. No.: US 2026/0005587 A1
(43) Pub. Date: Jan. 1, 2026

(54) MULTI-PROCESS-STEP STATOR MANUFACTURING DEVICE

(71) Applicant: SUZHOU TIANHONG LASER CO., LTD., Suzhou, Jiangsu (CN)

(72) Inventors: Guanghui CAO, Suzhou, Jiangsu (CN); Chaolong JIN, Suzhou, Jiangsu (CN)

(21) Appl. No.: 18/871,288

(22) PCT Filed: Dec. 25, 2023
(86) PCT No.: PCT/CN2023/141547

§ 371 Date: Dec. 3, 2024

(30) Foreign Application Priority Data
Dec. 30, 2022 (CN) 202211723900.X

(51) Int. Cl. H02K 15/021

(52) U.S. Cl. CPC H02K 15/021; H02K 2215/00

(57) ABSTRACT

Disclosed is a multi-process-step stator manufacturing device, including a first frame and a second frame that are arranged side by side, where the first frame is provided with a turntable, a press machine, a welding assembly and an ejecting assembly, and the second frame is provided with two frame slide rails, a connecting and handling module, a marking assembly, an air shower assembly, two axial handling assemblies, a detection assembly, an oil injection assembly, and a discharging assembly. The apparatus of the present disclosure combines processes of press fitting, welding, marking, air showering, detecting, and injecting oil, and realizes automatic operation and processing according to each process, thereby improving processing efficiency and ensuring stator processing quality.

### TECHNICAL FIELD

The present disclosure relates to the technical field of motor manufacturing, and particularly relates to a multi-process-step stator manufacturing device.

### BACKGROUND

A motor stator is formed by a plurality of annular iron cores. During manufacturing, the plurality of annular iron cores need to be stacked and calibrated, and after a plurality of processes such as pressing, welding at a plurality of spots, marking, air showering, detecting, anti-rust oil injecting, and the like, qualified products and defective products are identified before discharging. However, manual execution of the above processes not only results in low efficiency, but also cannot guarantee the effectiveness of each process or the processing quality of products.

### SUMMARY

In order to solve the above problems, the present disclosure provides a multi-process-step stator manufacturing device.

According to one aspect of the present invention, a multi-process-step stator manufacturing device is provided, including a first frame and a second frame that are arranged side by side, where the first frame is provided with a turntable, a press machine, a welding assembly and an ejecting assembly, and the second frame is provided with two frame slide rails, a connecting and handling module, a marking assembly, an air shower assembly, two axial handling assemblies, a detection assembly, an oil injection assembly, and a discharging assembly;
four tooling assemblies are installed on the turntable, and the press machine, the welding assembly and the ejecting assembly are located at stations of three sequentially adjacent tooling assemblies;
the connecting and handling module is located above the turntable, the ejecting assembly and the marking assembly, and the connecting and handling module, the marking assembly and the air shower assembly are all located above the frame slide rails; and
the two axial handling assemblies are perpendicular to each other, one axial handling assembly is located above the air shower assembly and the detection module, and the other axial handling assembly is located above the detection assembly, the oil injection assembly and the discharging assembly.

In some embodiments, an electric cabinet, a laser, a water tank and a fan that are independently arranged are further included. The benefits lie in that an external structure of each frame of the apparatus is described.

In some embodiments, the press machine includes a mounting frame, and a gas-liquid pressure cylinder, a press-fit pressure head, a hollow pressure seat, a horizontal cylinder and a lower plug block are installed on the mounting frame, where the press-fit pressure head is connected to the bottom of the gas-liquid pressure cylinder and located above the tooling assembly, the hollow pressure seat is located below the tooling assembly, and the lower plug block is connected to a side surface of the horizontal cylinder and can be pushed into the hollow pressure seat. The benefits lie in that a structure of the press machine is described.

In some embodiments, the welding assembly includes a welding support frame, a planetary reducer, a pre-press pressure head, a plurality of linear modules, and a plurality of welding heads, where the planetary reducer is installed on the top of the welding support frame, the pre-press pressure head is connected to the bottom of the planetary reducer and is located above the tooling assembly, each linear module is vertically arranged and installed on the welding support frame, and each welding head is slidably installed on each linear module and is located around the periphery of the tooling assembly. The benefits lie in that a structure of the welding assembly is described.

In some embodiments, the ejecting assembly includes an ejecting motor, a vertical transmission ejecting shaft, a horizontal ejecting lifting plate, and four vertical ejecting rods, where a rotor of the ejecting motor is in transmission connection with the transmission ejecting shaft, the ejecting lifting plate is installed on the transmission ejecting shaft, and each ejecting rod is installed on the top of the ejecting lifting plate. The benefits lie in that a structure of the ejecting assembly is described.

In some embodiments, the marking assembly includes a vertical lifting table, a geared motor, an optical bench and at least one marking head, where the geared motor is installed at the bottom of the vertical lifting table, the optical bench is slidably installed on a side surface of the vertical lifting table, a vibrating mirror is installed on the optical bench, and each marking head is connected below the optical bench. The benefits lie in that a structure of the marking assembly is described.

In some embodiments, the air shower assembly includes an air shower hood, an air shower lifting plate, an air shower lifting cylinder, a nozzle assembly and four distributing sliding assemblies, where the air shower lifting plate is slidably installed above the air shower hood, the air shower lifting cylinder is installed on the air shower lifting plate and is in transmission connection with the nozzle assembly, the nozzle assembly is located inside the air shower hood, and each distributing sliding assembly is installed on the top of the air shower hood and is located below the air shower lifting plate. The benefits lie in that a structure of the air shower assembly is described.

In some embodiments, the detection assembly includes a detection support, a horizontal detection slide table and two detection cameras, where the horizontal detection slide table is installed on an upper side surface of the detection support, and two detection cameras are arranged side by side and slidably installed on the horizontal detection slide table.

In some embodiments, the oil injection assembly includes an oil injection rack box, an oil injection lifting base, a rotating mounting base and two oil injection heads, where the oil injection lifting base and the rotating mounting base are installed in the oil injection rack box, the oil injection lifting base is connected with an oil injection lifting motor, one oil injection head is slidably installed on the oil injection lifting base and located directly above the rotating mounting base, and the other oil injection head is fixedly installed on the oil injection lifting base and located on a side surface above the rotating mounting base. The benefits lie in that a structure of the oil injection assembly is described.

In some embodiments, the discharging assembly includes a material distributing cylinder, a material conveying platform and two discharging channels, where the material conveying platform is slidably installed on the material distributing cylinder, and the two discharging channels are arranged side by side on a side surface of the material distributing cylinder. The benefits lie in that a structure of the discharging assembly is described.

### BRIEF DESCRIPTION OF THE DRAWINGS

FIG. 1 is a structural schematic diagram of a multi-process-step stator manufacturing device according to an implementation of the present disclosure.

FIG. 2 is a structural schematic diagram of a first frame shown in FIG. 1.

FIG. 3 is a structural schematic diagram of a second frame shown in FIG. 1.

FIG. 4 is a structural schematic diagram of a turntable shown in FIG. 2.

FIG. 5 is a structural schematic diagram of a press machine shown in FIG. 2.

FIG. 6 is a structural schematic diagram of a welding assembly shown in FIG. 2.

FIG. 7 is a structural schematic diagram of an ejecting assembly shown in FIG. 2.

FIG. 8 is a structural schematic diagram of a connecting and handling module shown in FIG. 3.

FIG. 9 is a structural schematic diagram of a marking assembly shown in FIG. 3.

FIG. 10 is a structural schematic diagram of an air shower assembly shown in FIG. 3.

FIG. 11 is a structural schematic diagram of an axial handling assembly shown in FIG. 3.

FIG. 12 is a structural schematic diagram of a detection assembly shown in FIG. 3.

FIG. 13 is a structural schematic diagram of an oil injection assembly shown in FIG. 3.

FIG. 14 is a structural schematic diagram of a discharging assembly shown in FIG. 3.

In the figures: first frame 1, turntable 2, press machine 3, welding assembly 4, ejecting assembly 5, connecting and handling module 6, marking assembly 7, air shower assembly 8, axial handling assembly 9, detection assembly 10, oil injection assembly 11, discharging assembly 12, second frame 13, frame slide rail 14, electric cabinet 15, laser 16, water tank 17, fan 18, tooling assembly 21, mold core 22, ejecting ring 23, ejecting plug 24, mounting frame 31, gas-liquid pressure cylinder 32, press-fit pressure head 33, hollow pressure seat 34, horizontal cylinder 35, lower plug block 36, welding support frame 41, planetary reducer 42, pre-press pressure head 43, linear module 44, welding head 45, ejecting motor 51, transmission ejecting shaft 52, ejecting lifting plate 53, ejecting rod 54, base 55, vertical slide rail 56, horizontal connecting and handling slide table 61, vertical connecting and handling slide table 62, sliding clamping block 63, clamping cylinder 64, vertical lifting table 71, geared motor 72, optical bench 73, marking head 74, vibrating mirror 75, air shower hood 81, air shower lifting plate 82, air shower lifting cylinder 83, nozzle assembly 84, distributing sliding assembly 85, lifting door 86, axial horizontal handling slide table 91, axial vertical handling slide table 92, inner opening and closing chuck 93, opening and closing cylinder 94, product 100, detection support 101, horizontal detection slide table 102, detection camera 103, oil injection rack box 111, oil injection lifting base 112, rotating mounting base 113, oil injection head 114, oil injection lifting motor 115, material distributing cylinder 121, material conveying platform 122, discharging channel 123, and rolling roller 124.

### DETAILED DESCRIPTIONS OF THE EMBODIMENTS

The present disclosure will be further described in detail below with reference to the accompanying drawings.

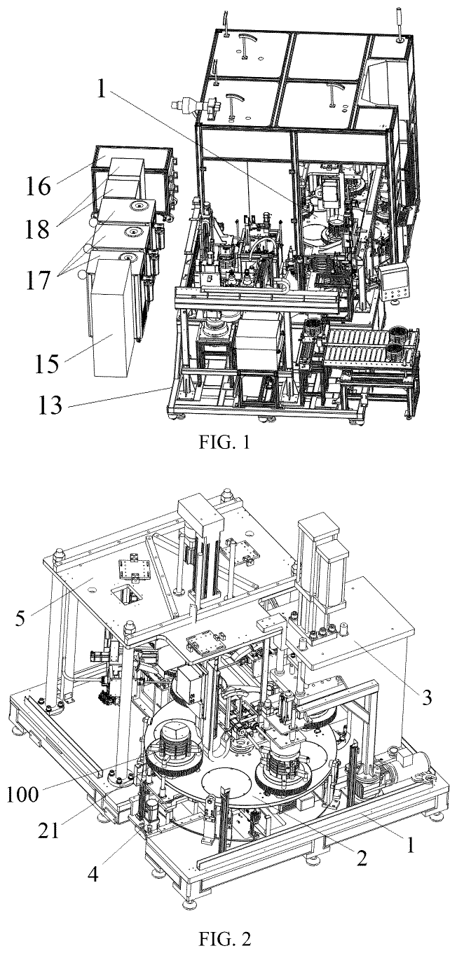

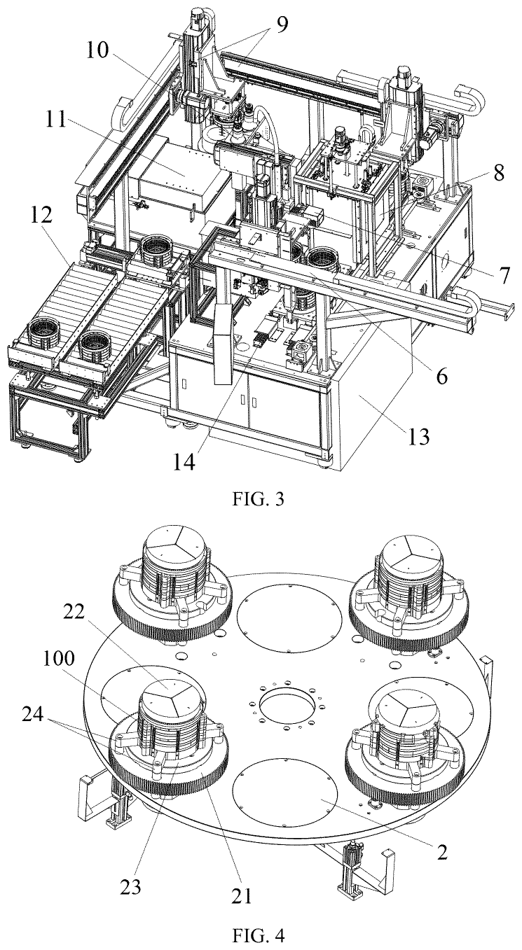

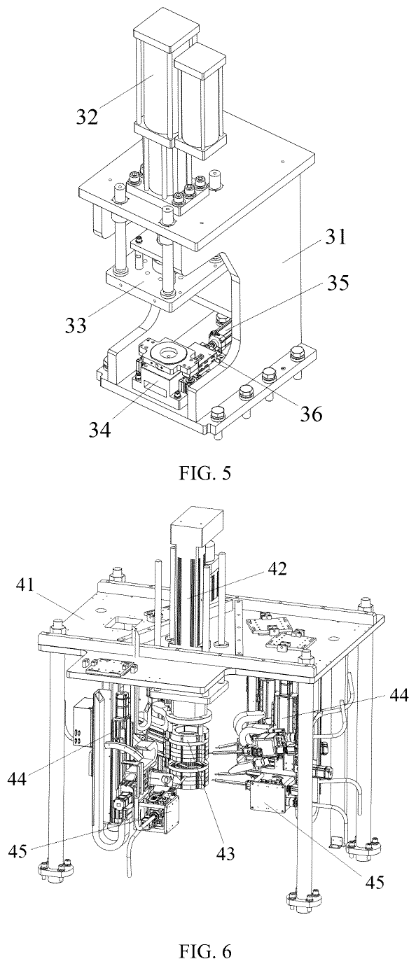

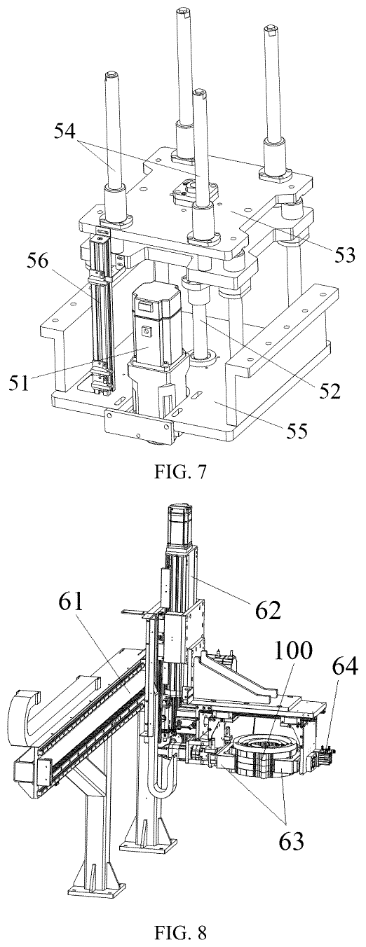

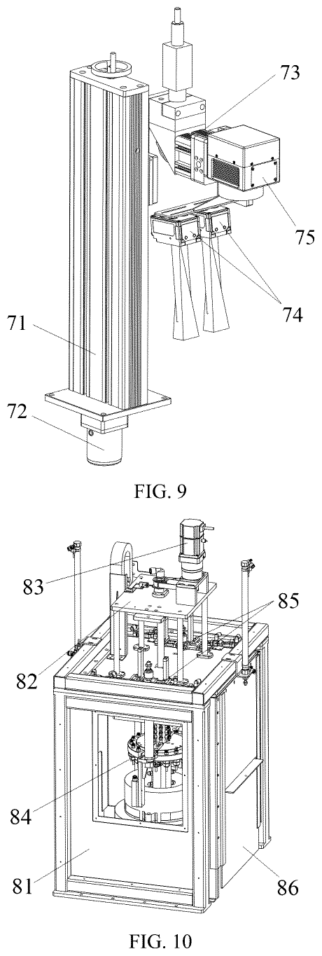

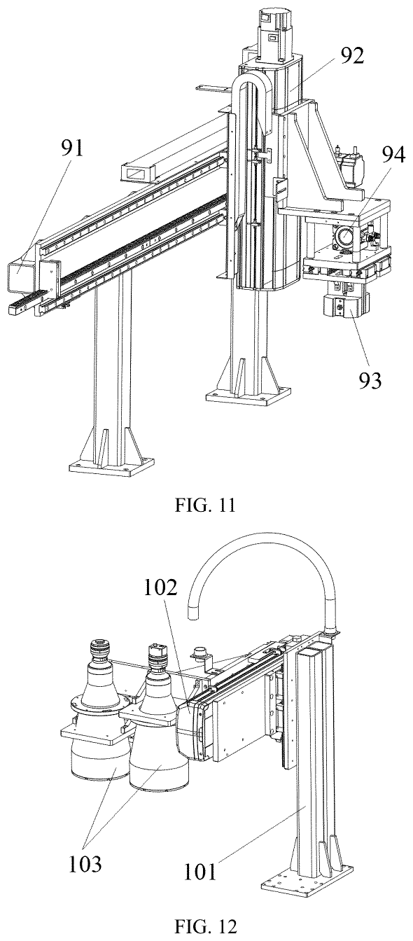

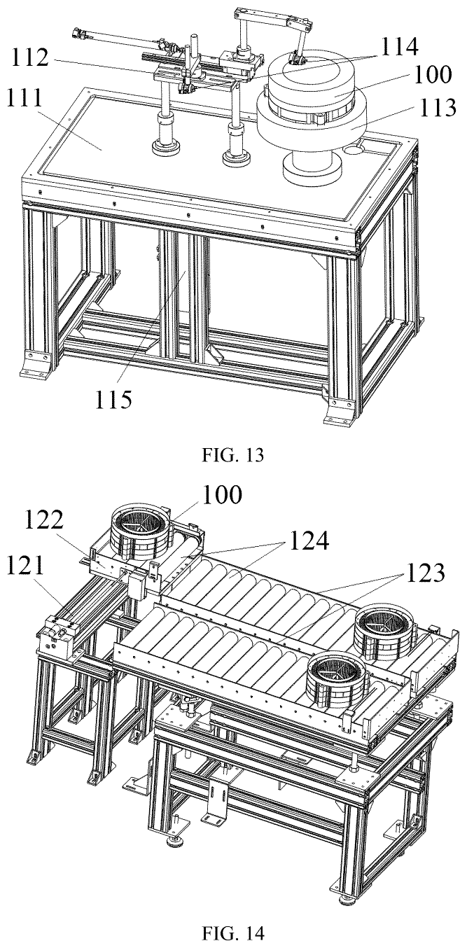

FIG. 1 schematically illustrates a structure of a multi-process-step stator manufacturing device according to an implementation of the present disclosure. FIG. 2 illustrates a structure of a first frame in FIG. 1. FIG. 3 illustrates a structure of a second frame in FIG. 1. FIG. 4 illustrates a structure of a turntable in FIG. 2. FIG. 5 illustrates a structure of a press machine in FIG. 2. FIG. 6 illustrates a structure of a welding assembly in FIG. 2. FIG. 7 illustrates a structure of an ejecting assembly in FIG. 2. FIG. 8 illustrates a structure of a connecting and handling module in FIG. 3. FIG. 9 illustrates a structure of a marking assembly in FIG. 3. FIG. 10 illustrates a structure of an air shower assembly in FIG. 3. FIG. 11 illustrates a structure of an axial handling assembly in FIG. 3. FIG. 12 illustrates a structure of a detection assembly in FIG. 3. FIG. 13 illustrates a structure of an oil injection assembly in FIG. 3. FIG. 14 illustrates a structure of a discharging assembly in FIG. 3.

As shown in FIGS. 1-2, the multi-process-step stator manufacturing device includes a first frame 1 and a second frame 13, where the first frame 1 and the second frame 13 are arranged side by side. Some assemblies, including a turntable 2, a press machine 3, a welding assembly 4, an ejecting assembly 5, and the like, are installed on the first frame 1. Other assemblies, including a connecting and handling module 6, a marking assembly 7, an air shower assembly 8, two axial handling assemblies 9, a detection assembly 10, an oil injection assembly 11, a discharging assembly 12, and so forth, are installed on the second frame 13.

Four stations are evenly distributed on the circumference of the turntable 2 of the first frame 1, four tooling assemblies 21 are respectively installed on the four stations, and the four tooling assemblies 21 are configured for installing products 100 to be processed. When one of the stations is a loading station, three adjacent stations in a counterclockwise direction are respectively a press-fit station, a welding station and an ejecting station, and the press machine 3, the welding assembly 4 and the ejecting assembly 5 are respectively located at the press-fit station, the welding station and the ejecting station.

Two frame slide rails 14 are laid on the second frame 13, either frame slide rail 14 is provided with a power apparatus, and a sliding plate is installed on both of the two frame slide rails, so that the product 100 on the sliding plate can slide along the frame slide rail 14. The connecting and handling module 6, the marking assembly 7 and the air shower assembly 8 are all located above the two frame slide rails 14. The connecting and handling module 6 is located above the ejecting station of the turntable 2, the ejecting assembly 5 and the marking assembly 7, and is capable of transferring the product 100 on the tooling assembly 21 located at the ejecting station of the turntable 2 to the marking assembly 7.

The two axial handling assemblies 9 on the second frame 13 are perpendicular to each other, and one axial handling assembly 9 is located above the air shower assembly 8 and a detection module and is capable of handling the product 100 from the air shower assembly 8 to the detection module. The other axial handling assembly 9 is located above the detection assembly 10, the oil injection assembly 11 and the discharging assembly 12, and is capable of handling the product 100 between the above assemblies.

Further, apparatus such as an electric cabinet 15, a laser 16, a water tank 17, a fan 18 and other apparatuses are independently arranged outside the first frame 1 and the second frame 13. The number and connection methods of these apparatuses can be reasonably set according to situations to assist the processing work.

As shown in FIG. 4, the tooling assembly 21 on the turntable 2 includes a mold core 22, the product 100 formed by a plurality of annular iron cores can be sleeved on the mold core 22, an ejecting ring 23 is further sleeved on the mold core 22, the ejecting ring 23 is located below the product 100, and four ejecting plugs 24 protrude from the periphery of the ejecting ring 23.

As shown in FIG. 5, the press machine 3 includes a mounting frame 31, the mounting frame 31 is installed on the first frame 1, and a gas-liquid pressure cylinder 32, a press-fit pressure head 33 and a hollow pressure seat 34 are installed on the mounting frame 31. The gas-liquid pressure cylinder 32 is installed on the top of the mounting frame 31, the press-fit pressure head 33 is connected to a push rod located at the bottom of the gas-liquid pressure cylinder 32, the press-fit pressure head 33 is located above the tooling assembly 21 at the current station, and the hollow pressure seat 34 is located below the tooling assembly 21. Thus, when the gas-liquid pressure cylinder 32 works, the press-fit pressure head 33 can be pushed downward, to press the product 100 on the tooling assembly 21 onto the hollow pressure seat 34 so as to complete the press fitting of the product 100.

Further, a horizontal cylinder 35 and a lower plug block 36 are installed on the mounting frame 31, the lower plug block 36 is connected to a piston rod on a side surface of the horizontal cylinder 35, and through the operation of the horizontal cylinder 35, the lower plug block 36 can be pushed to a hollow portion of the hollow pressure seat 34.

As shown in FIG. 6, the welding assembly 4 includes a welding support frame 41, a planetary reducer 42 (connected with a servo motor), a pre-press pressure head 43, a plurality of linear modules 44, and a plurality of welding heads 45 (three to four). The welding support frame 41 is installed on the first frame 1, the planetary reducer 42 is installed on the top of the welding support frame 41, and the pre-press pressure head 43 is connected to the bottom of the planetary reducer 42 and is located above the tooling assembly 21 at the current station, which is capable of pre-pressing the product 100 on the tooling assembly 21.

Further, each linear module 44 is vertically arranged and installed on the welding support frame 41, and each welding head 45 is slidably installed on each linear module 44 and is located around the periphery of the tooling assembly 21, which enables welding of the product 100 on the tooling assembly 21 at a plurality of spots simultaneously.

As shown in FIG. 7, the ejecting assembly 5 includes an ejecting motor 51, a vertical transmission ejecting shaft 52, a horizontal ejecting lifting plate 53, and four vertical ejecting rods 54, where the ejecting motor 51 and the transmission ejecting shaft 52 are both installed on a base 55, a rotor of the ejecting motor 51 is located at the bottom thereof and is in transmission connection with the transmission ejecting shaft 52 through a pulley (not shown in the figure), the ejecting lifting plate 53 is installed on the transmission ejecting shaft 52 (which can also be slidably installed on the first frame 1 through a vertical slide rail 56), and each ejecting rod 54 is installed on the top of the ejecting lifting plate 53 and is located just below the four ejecting plugs 24 of the tooling assembly 21 at the current station.

When the ejecting motor 51 works, the ejecting lifting plate 53 and each ejecting rod 54 can be driven to rise by means of the transmission ejecting shaft 52 to withstand each ejecting plug 24, so that the ejecting ring 23 on the tooling assembly 21 and the product 100 can be lifted up and detached from the mold core 22.

As shown in FIG. 8, the connecting and handling module 6 includes a horizontal connecting and handling slide table 61, a vertical connecting and handling slide table 62, two sliding clamping blocks 63 and two clamping cylinders 64, where the horizontal connecting and handling slide table 61 is installed on the second frame 13, the vertical connecting and handling slide table 62 is slidably installed on the horizontal connecting and handling slide table 61, the two sliding clamping blocks 63 are both slidably installed on a side surface of the vertical connecting and handling slide table 62 and are oppositely arranged, the two clamping cylinders 64 are respectively connected to the two sliding clamping blocks 63, and the two clamping cylinders 64 in operation can push the two sliding clamping blocks 63.

When the connecting and handling module 6 works, the product 100 ejected by the ejecting assembly 5 can be clamped jointly by the horizontal connecting and handling slide table 61, the vertical connecting and handling slide table 62 and the two sliding clamping blocks 63 that are in fit with each other, and then is transferred to the two frame slide rails 14 of the second frame 13.

As shown in FIG. 9, the marking assembly 7 includes a vertical lifting table 71, a geared motor 72, an optical bench 73 and at least one (two in the figure) marking head 74, where the vertical lifting table 71 is installed on the second frame 13, the geared motor 72 is installed at the bottom of the vertical lifting table 71 (generally hidden inside the second frame 13), the optical bench 73 is slidably installed on a side surface of the vertical lifting table 71 and connected with the geared motor 72, and a vibrating mirror 75 is installed on the optical bench 73. Each marking head 74 is connected below the optical bench 73 and a marking direction is aligned with the two frame slide rails 14 below.

When the product 100 moves to the marking assembly 7 along the two frame slide rails 14, the optical bench 73 slides along the vertical lifting table 71 and reaches an appropriate height through adjustment, and then each marking head 74 can be used for marking the product 100 below.

As shown in FIG. 10, the air shower assembly 8 includes a sealed air shower hood 81 (part of the cover body is removed in the figure to show its internal structure), lifting doors 86 are arranged on front and rear sides of the air shower hood 81, and the lifting doors 86 can drive the product 100 on the frame slide rail 14 slide to the inside of the air shower hood 81.

An air shower lifting plate 82 and an air shower lifting cylinder 83 are installed on the top of the air shower assembly 8, and a nozzle assembly 84 is installed inside, where the air shower lifting plate 82 is slidably installed on the top of the air shower assembly 8 through a rotating shaft and a plurality of lifting shafts, and the air shower lifting cylinder 83 is installed on the air shower lifting plate 82 and connected with the rotating shaft, while the bottom of the rotating shaft extends into the inside of the air shower hood 81 and is connected to the nozzle assembly 84, so that the air shower lifting cylinder 83 is in transmission connection with the nozzle assembly 84, and a plurality of nozzles are arranged around the periphery of the nozzle assembly 84.

When the product 100 moves along the two frame slide rails 14 and enters the inside of the air shower hood 81 of the air shower assembly 8, the lifting door 86 is lifted down first, then the air shower lifting cylinder 83 works to lift the nozzle assembly 84 to an appropriate height, and finally gas is ejected from the nozzle for air shower cleaning of the product 100.

Further, distributing sliding assemblies 85 are installed on the top of the air shower hood 81 and distributed on both sides below the air shower lifting plate 82, each distributing sliding assembly 85 can adjust its own position and obstruct the upper air shower lifting plate 82 when it descends, and the nozzle assembly 84 can be stopped at an appropriate height for air shower work, depending on a specific type of the product 100.

As shown in FIG. 11, the axial handling assembly 9 includes an axial horizontal handling slide table 91, an axial vertical handling slide table 92, an inner opening and closing chuck 93 and an opening and closing cylinder 94, where the axial horizontal handling slide table 91 is installed on the second frame 13, the axial vertical handling slide table 92 is slidably installed on the axial horizontal handling slide table 91, the inner opening and closing chuck 93 is slidably installed on a side surface of the axial vertical handling slide table 92, and the opening and closing cylinder 94 is connected to the inner opening and closing chuck 93, which can control the opening and closing of the inner opening and closing chuck 93.

When the product 100 moves to one axial handling assembly 9 along the two frame slide rails 14, the axial handling assembly 9, through the axial horizontal handling slide table 91 and the axial vertical handling slide table 92, makes the inner opening and closing chuck 93 extend into the inside of the product 100, the opening and closing cylinder 94 works to make the inner opening and closing chuck 93 clamp the product 100, then the product 100 is transferred to a position below the detection assembly 10, and after detection by the detection assembly 10, the product is transferred again by the other axial handling assembly 9.

As shown in FIG. 12, the detection assembly 10 includes a detection support 101, a horizontal detection slide table 102 and two detection cameras 103, where the detection assembly 10 is installed on the second frame 13, the horizontal detection slide table 102 is installed on an upper side surface of the detection support 101, and two detection cameras 103 are slidably installed side by side on the horizontal detection slide table 102, with the lenses facing downwards.

When the product 100 is transferred to a position below the detection assembly 10, the detection assembly 10 detects the product 100 through the detection camera 103, where detected qualified products are transferred to the oil injection assembly 11 by the axial handling assembly 9, while defective products are transferred onto the discharging assembly 12 by the axial handling assembly 9.

As shown in FIG. 13, the oil injection assembly 11 includes a sealed oil injection rack box 111 (a movable top plate is installed on the oil injection rack box 111, and the box body is removed in the figure to show its internal structure), and an oil injection lifting base 112, a rotating mounting base 113 and two oil injection heads 114 are installed on the oil injection rack box 111. The oil injection lifting base 112 and the rotating mounting base 113 are installed in the oil injection rack box 111, the oil injection lifting base 112 is connected with an oil injection lifting motor 115, and the two oil injection heads 114 are both slidably installed on the oil injection lifting base 112 and can vertically lift along with the operation of the oil injection lifting motor 115, where one oil injection head 114 is located directly above the rotating mounting base 113, and the other oil injection head 114 is located on a side surface above the rotating mounting base 113.

The rotating mounting base 113 can be configured to install the product 100, and the product 100 installed on the rotating mounting base 113 can rotate together with the rotating mounting base 113. When the two oil injection heads 114 are lifted, one oil injection head 114 extends into the inside of the product 100 and injects oil on an inner peripheral surface thereof with rotation of the product 100, while the other oil injection head 114 located outside the product 100 can inject oil on an outer peripheral surface thereof with the rotation of the product 100.

The qualified products detected by the detection assembly 10 are subject to oil injection on the oil injection assembly 11, and then are transferred to the discharging assembly 12 by the axial handling assembly 9.

As shown in FIG. 14, the discharging assembly 12 includes a material distributing cylinder 121, a material conveying platform 122 and two discharging channels 123, where a plurality of rolling rollers 124 are arranged side by side on the material conveying platform 122 and the two discharging channels 123. The material conveying platform 122 is slidably installed on the material distributing cylinder 121, the two discharging channels 123 are arranged side by side on a side surface of the material distributing cylinder 121, and the material conveying platform 122 can slide thereon with the operation of the material distributing cylinder 121, so that the material conveying platform 122 can be adjusted to a position corresponding to the two discharging channels 123 respectively according to the situations.

When the product 100 is transferred to the discharging assembly 12 and falls onto the material conveying platform 122, the material conveying platform 122 will slide and adjust its own position according to the specific situation, so that the qualified products and the defective products in the products 100 can be discharged from two different discharging channels 123.

A process of processing and manufacturing the product 100 by use of the multi-process-step stator manufacturing device includes the following steps:
S1, loading: loading and installing the product 100 on the tooling assembly 21 at the loading station of the turntable 2;
S2, press fitting: rotating the turntable 2 to transfer the product 100 to the press-fit station, and press-fitting the product 100 by using the press machine 3;
S3, welding: rotating the turntable 2 to transfer the product 100 to the welding station, pre-pressing the product 100 through the pre-press pressure head 43 of the welding assembly 4, and welding the product 100 at a plurality of spots simultaneously through the welding heads 45;
S4, ejecting: rotating the turntable 2 to transfer the product 100 to the ejecting station, and using the ejecting motor 51 and each ejecting rod 54 to push upwards the product 100 out of the tooling assembly 21;
S5, first transfer: handling the product 100 onto the two frame slide rails 14 of the second frame 13 for sliding through the connecting and handling module 6;
S6, marking: sliding the product 100 to the marking assembly 7, and marking the product 100 through the marking assembly 7;
S7, air showering: sliding the product 100 to the air shower assembly 8, and performing air shower cleaning of the product 100 through the air shower assembly 8;
S8, second transfer: sliding the product 100 to one axial handling assembly 9, and handling the product 100 to the detection assembly 10 through the axial handling assembly 9;
S9, detection: detecting the product 100 through the detection assembly 10, and determining whether the product 100 is a qualified product or a defective product;
S10, third transfer: handling the product 100 through the other axial handling assembly 9, putting qualified products onto the oil injection assembly 11, and placing defective products onto the discharging assembly 12;
S11, oil injection: injecting oil on the inside and outside of the qualified product through the oil injection assembly 11, and then placing it onto the discharging assembly 12; and
S12, discharging: discharging the qualified products and the defective products from two different discharging channels 123 respectively by using the discharging assembly 12.

The above are merely some implementations of the present disclosure. For those of ordinary skill in the art, they may also make several transformations and improvements on the premise of not deviating from the inventive concept of the present disclosure, and these transformations and improvements shall fall within the scope of protection of the present disclosure.

What it claimed is:

1. A multi-process-step stator manufacturing device, comprising a first frame and a second frame that are arranged side by side, wherein the first frame is provided with a turntable, a press machine, a welding assembly, an ejecting assembly, and the second frame is provided with two frame slide rails, a connecting and handling module, a marking assembly, an air shower assembly, two axial handling assemblies, a detection assembly, an oil injection assembly, and a discharging assembly;
four tooling assemblies are installed on the turntable, and the press machine, the welding assembly and the ejecting assembly are located at stations of three sequentially adjacent tooling assemblies;
the connecting and handling module is located above the turntable, the ejecting assembly and the marking assembly, and the connecting and handling module, the marking assembly and the air shower assembly are all located above the frame slide rails; and
the two axial handling assemblies are perpendicular to each other, one axial handling assembly is located above the air shower assembly and a detection module, and the other axial handling assembly is located above the detection assembly, the oil injection assembly and the discharging assembly.

2. The multi-process-step stator manufacturing device according to claim 1, further comprising an electric cabinet, a laser, a water tank and a fan that are independently arranged.

3. The multi-process-step stator manufacturing device according to claim 1, wherein the press machine comprises a mounting frame, and a gas-liquid pressure cylinder, a press-fit pressure head, a hollow pressure seat, a horizontal cylinder and a lower plug block are installed on the mounting frame, wherein the press-fit pressure head is connected to the bottom of the gas-liquid pressure cylinder and located above the tooling assembly, the hollow pressure seat is located below the tooling assembly, and the lower plug block is connected to a side surface of the horizontal cylinder and can be pushed into the hollow pressure seat.

4. The multi-process-step stator manufacturing device according to claim 1, wherein the welding assembly comprises a welding support frame, a planetary reducer, a pre-press pressure head, a plurality of linear modules, and a plurality of welding heads, wherein the planetary reducer is installed on the top of the welding support frame, the pre-press pressure head is connected to the bottom of the planetary reducer and is located above the tooling assembly, each linear module is vertically arranged and installed on the welding support frame, and each welding head is slidably installed on each linear module and is located around the periphery of the tooling assembly.

5. The multi-process-step stator manufacturing device according to claim 1, wherein the ejecting assembly comprises an ejecting motor, a vertical transmission ejecting shaft, a horizontal ejecting lifting plate, and four vertical ejecting rods, wherein a rotor of the ejecting motor is in transmission connection with the transmission ejecting shaft, the ejecting lifting plate is installed on the transmission ejecting shaft, and each ejecting rod is installed on the top of the ejecting lifting plate.

6. The multi-process-step stator manufacturing device according to claim 1, wherein the marking assembly comprises a vertical lifting table, a geared motor, an optical bench and at least one marking head, wherein the geared motor is installed at the bottom of the vertical lifting table, the optical bench is slidably installed on a side surface of the vertical lifting table, a vibrating mirror is installed on the optical bench, and each marking head is connected below the optical bench.

7. The multi-process-step stator manufacturing device according to claim 1, wherein the air shower assembly comprises an air shower hood, an air shower lifting plate, an air shower lifting cylinder, a nozzle assembly and four distributing sliding assemblies, wherein the air shower lifting plate is slidably installed above the air shower hood, the air shower lifting cylinder is installed on the air shower lifting plate and is in transmission connection with the nozzle assembly, the nozzle assembly is located inside the air shower hood, and each distributing sliding assembly is installed on the top of the air shower hood and is located below the air shower lifting plate.

8. The multi-process-step stator manufacturing device according to claim 1, wherein the detection assembly comprises a detection support, a horizontal detection slide table and two detection cameras, wherein the horizontal detection slide table is installed on an upper side surface of the detection support, and two detection cameras are arranged side by side and slidably installed on the horizontal detection slide table.

9. The multi-process-step stator manufacturing device according to claim 1, wherein the oil injection assembly comprises an oil injection rack box, an oil injection lifting base, a rotating mounting base and two oil injection heads, wherein the oil injection lifting base and the rotating mounting base are installed in the oil injection rack box, the oil injection lifting base is connected with an oil injection lifting motor, one oil injection head is slidably installed on the oil injection lifting base and located directly above the rotating mounting base, and the other oil injection head is fixedly installed on the oil injection lifting base and located on a side surface above the rotating mounting base.

10. The multi-process-step stator manufacturing device according to claim 1, wherein the discharging assembly comprises a material distributing cylinder, a material conveying platform and two discharging channels, wherein the material conveying platform is slidably installed on the material distributing cylinder, and the two discharging channels are arranged side by side on a side surface of the material distributing cylinder.
